(19) United States
(12) Patent Application Publication
(10) Pub. No.: US 2025/0251580 A1
(43) Pub. Date: Aug. 7, 2025

(54) OPTICAL SYSTEM AND OPTICAL CAMERA WORKING AT FAR-INFRARED WAVEBAND

(71) Applicant: SHENZHEN METALENX TECHNOLOGY CO.,LTD, Shenzhen (CN)

(72) Inventors: Shuangyu GU, Shenzhen (CN); Heshan LIN, Shenzhen (CN); Chenglong HAO, Shenzhen (CN); Fengze TAN, Shenzhen (CN); Jian ZHU, Shenzhen (CN)

(73) Assignee: SHENZHEN METALENX TECHNOLOGY CO.,LTD, Shenzhen (CN)

(21) Appl. No.: 19/034,556

(22) Filed: Jan. 23, 2025

(30) Foreign Application Priority Data
Feb. 6, 2024 (CN) 202410168872.2

(51) Int. Cl. G02B 13/14; G02B 13/18

(52) U.S. Cl. CPC G02B 13/14; G02B 13/18

(57) ABSTRACT

An optical system and an optical camera working at the far-infrared waveband are provided, the optical system working at the far-infrared waveband includes a first refractive lens, a metalens, and a second aspheric lens in order from an object side to an image side; each of the first refractive lens, the metalens, and the second aspheric lens has a positive focal power; each of the first refractive lens, the metalens, and the second aspheric lens includes an object-side surface facing towards the object side and an image-side surface facing towards the image side; the first refractive lens is a meniscus lens, and both the object-side surface and the image-side surface of the first refractive lens are convex to the object side; the second aspheric lens is a meniscus lens, and both the object-side surface and the image-side surface of the first refractive lens are convex to the image side.

### CROSS-REFERENCE TO RELATED APPLICATION

This application claims the benefit of priority from Chinese Patent Application No.202410168872.2, filed on Feb. 6, 2024. The content of the aforementioned application, including any intervening amendments thereto, is incorporated herein by reference in its entirety.

### TECHNICAL FIELD

The present disclosure relates to a field of lens, in particular to an optical system and an optical camera working at a far-infrared waveband.

### BACKGROUND

Compared with the optical device working at a visible waveband, the optical device working at a far-infrared waveband will have better imaging performance in rainy, snowy, foggy, night environment or other environments, therefore the optical device working at the far-infrared waveband is widely used in security, vehicle or other fields. For the optical equipment working at the far-infrared waveband, the optical system working at the far-infrared waveband provided by the related technology has defects of great difficulty in lens processing and larger total track length (TTL).

### SUMMARY OF INVENTION

One purpose of the present application is to provide an optical system and an optical camera working at far-infrared waveband, and the optical system working at far-infrared waveband provided by the present application can reduce the difficulty of lens processing and reduce the total track length.

In the First Aspect, an Optical System Working at a Far-Infrared Waveband is Provided, the Optical System Includes a First Refractive Lens, a Metalens, and a Second Aspheric Lens in Order from an Object Side to an Image Side;
wherein, each of the first refractive lens, the metalens, and the second aspheric lens has a positive focal power;
each of the first refractive lens, the metalens, and the second aspheric lens comprises an object-side surface facing towards the object side and an image-side surface facing towards the image side;
the first refractive lens is a meniscus lens, and both the object-side surface and the image-side surface of the first refractive lens are convex to the object side;
the second aspheric lens is a meniscus lens, and both the object-side surface and the image-side surface of the second aspheric lens are convex to the image side.

In one embodiment, the first refractive lens is a spherical lens.

In one embodiment, the first refractive lens is an aspherical lens.

In one embodiment, the second aspheric lens is an even-order aspheric lens; and when the first refractive lens is an aspheric lens, the first refractive lens is an even-aspheric lens.

In one embodiment, the even-order aspheric surface of the even-aspheric len satisfies the formula as follows:

$$Z ( r ) = \frac{c {r}^{2}}{1 + \sqrt{1 - ( 1 + k ) {c}^{2} {r}^{2}}} + A {r}^{4} + B {r}^{6} + C {r}^{8} + D {r}^{10}$$

wherein r is a radius of any position of the aspheric surface in a radial direction, Z(r) is a vector height of the aspheric surface, c is a curvature of the aspheric surface, k is a conic coefficient, A is a four-order aspheric coefficient, B is a six-order aspheric coefficient, C is an eight-order aspheric coefficient, D is a ten-order aspheric coefficient.

In one embodiment, the optical system working at the far-infrared waveband satisfies the condition as follows:

$$\frac{f}{D} < 1.1$$

wherein f is an effective focal length of the optical system working at the far-infrared waveband, and D is an entrance pupil diameter of the optical system working at the far-infrared waveband.

In one embodiment, the optical system working at the far-infrared waveband satisfies the condition as follows:

$$\frac{f}{D} < 0.98 .$$

In one embodiment, the optical system working at the far-infrared waveband satisfies the condition with a unit of 1/° C. as follows:

$$- 9.00 E - 05 < \frac{{n}_{a 1} * \frac{d {n}_{a 1}}{d t} * f}{{f}_{a 1}} + \frac{{n}_{a 2} * \frac{d {n}_{a 2}}{d t} * f}{{f}_{a 2}} < 9.00 E - 05$$

wherein nₐ₁ is a refractive index of the first refractive lens,

$$\frac{d {n}_{a 1}}{dt}$$

is a refraction temperature coefficient of the first refractive lens, fₐ₁ is a focal length of the first refractive lens, f is an effective focal length of the optical system, nₐ₂ is a refractive index of the second aspheric lens,

$$\frac{d {n}_{a 2}}{dt}$$

is a retraction temperature coefficient of the second aspheric lens, fₐ₂ is a focal length of the second aspheric lens.

In one embodiment, the optical system satisfies the condition with a unit of 1/° C. as follows:

$$4. E - 05 < \frac{{n}_{a 1} * \frac{d {n}_{a 1}}{d t} * f}{{f}_{a 1}} + \frac{{n}_{a 2} * \frac{d {n}_{a 2}}{d t} * f}{{f}_{a 2}} < 8.00 E - 05 .$$

In one embodiment, the optical system working at the far-infrared waveband satisfies the condition with a unit of mm as follows:

$$4 < \frac{T T L * F O V}{f * B F L} < 6$$

wherein TTL is a total track length of the optical system working at the far-infrared waveband, FOV is a full field of view of the optical system working at the far-infrared waveband, f is an effective focal length of the optical system working at the far-infrared waveband, BFL is a back focal length of the optical system working at the far-infrared waveband.

In one embodiment, the optical system working at the far-infrared waveband satisfies the condition as follows:

$$0.1 < \vert \frac{{d}_{1} + {d}_{2}}{{R}_{1} + {R}_{2}} \vert * \frac{f}{{f}_{a 1}} < 0.6$$

$$0.1 < \vert \frac{{d}_{5} + {d}_{6}}{{R}_{5} + {R}_{6}} \vert * \frac{f}{{f}_{a 2}} < 0.6$$

wherein d₁ is a radius of an aperture of the object-side surface of the first refractive lens; d₂ is a radius of an aperture of the image-side surface of the first refractive lens; R₁ is a curvature radius of the object-side surface of the first refractive lens; R₂ s a curvature radius of the image-side surface of the first refractive lens; fₐ₁ is a focal length of the first refractive lens; d₅ is a radius of an aperture of the object-side surface of the second aspheric lens; d₆ is a radius of an aperture of the image-side surface of the second aspheric lens; R₅ is a curvature radius of the object-side surface of the second aspheric lens; R₆ is a curvature radius of the image-side surface of the second aspheric lens; fₐ₂ is a focal length of the second aspheric lens; f is an effective focal length of the optical system working at the far-infrared waveband.

In one embodiment, the optical system working at the far-infrared waveband satisfies the condition with a unit of mm/rad as follows:

$$0.01 < \frac{{d}_{m} * {f}_{m}}{φ * f} < 1.50$$

wherein dₘ is a radius of the metalens; fₘ is a focal length of the metalens; φ is a sum of the absolute values of a phase difference of a position interval of the phase curve, and the phase curve is used to describe phases at each position of the metalens in a radial direction, and the position interval of the phase curve from the center of the metalens to the edge of the metalens; f is an effective focal length of the optical system working at the far-infrared waveband.

In one embodiment, the optical system working at the far-infrared waveband satisfies the condition with a unit of mm/rad as follows:

$$0.02 < \frac{{d}_{m} * {f}_{m}}{φ * f} < 1.00 .$$

In one embodiment, the optical system working at the far-infrared waveband further comprises:
an aperture slot, and the aperture slot is set on the object side of the metalens.

In one embodiment, a total track length of the optical system working at the far-infrared waveband is less than 29 mm.

In one embodiment, a back focal length of the optical system working at the far-infrared waveband is greater than or equal to 9 mm, and is less than or equal to 9.45 mm.

In one embodiment, a focal length of the metalens is greater than or equal to 28.8 mm, and is less than or equal to 102 mm;
a focal length of the first refractive lens is greater than or equal to 26 mm, and is less than or equal to 47.7 mm;
a focal length of the second aspheric lens is greater than or equal to 17.9 mm, and is less than or equal to 43.3 mm.

In one embodiment, a radius of the metalens is greater than or equal to 5.8 mm, and is less than or equal to 8 mm.

In the second aspect, an optical camera working at the far-infrared waveband is provided, and the optical camera working at the far-infrared waveband includes an optical system working at the far-infrared waveband of claim 1 and an imaging detector;
the imaging detector is set on an image plane of the optical system working at the far-infrared waveband.

In one embodiment, the optical camera working at the far-infrared waveband further includes a window glass; the window glass is set between the second aspheric lens and the optical system working at the far-infrared.

The optical system working at the far-infrared waveband includes a first refractive lens, a metalens, and a second aspheric lens in order from an object side to an image side; each of the first refractive lens, the metalens, and the second aspheric lens has a positive focal power; each of the first refractive lens, the metalens, and the second aspheric lens comprises an object-side surface facing towards the object side and an image-side surface facing towards the image side; the first refractive lens is a meniscus lens, and both the object-side surface and the image-side surface of the first refractive lens are convex to the object side; the second aspheric lens is a meniscus lens, and both the object-side surface and the image-side surface of the second aspheric lens are convex to the image side. There is no lens that needs to be set with a point of inflection in the optical system working at the far-infrared waveband, therefore the difficulty of lens processing is reduced. And the metalens in the optical system can improve the design degree of freedom for the first refractive lens and the second aspheric lens effectively, thus the total track length of the optical system working at the far-infrared waveband has reduced.

Other features and advantages of the present application will become apparent by the detailed description below, or will be acquired in part by the practice of the present application.

It should be understood that the above general description and detailed details are exemplary only, and do not limit this application.

### BRIEF DESCRIPTION OF DRAWINGS

The above and other targets, features and advantages of the example embodiment thereof by reference to the accompanying drawings.

FIG. 1 shows an optical architecture diagram of the optical system working at the far-infrared waveband provided in the present application.

FIG. 2 shows a schematic diagram of the phase curve of the metalens in one embodiment of this application.

FIG. 3 shows a schematic diagram of the phase curve of the metalens in one embodiment of this application.

FIG. 4 shows an optical architecture diagram of the optical system working at the far-infrared waveband provided by one embodiment of the present application.

FIG. 5 shows an MTF diagram of the optical system working at the far-infrared waveband provided in an embodiment of this application.

FIG. 6 shows an MTF graph of a working environment of −40° C. of the optical system working at the far-infrared waveband provided by an embodiment of the present application.

FIG. 7 shows an MTF diagram of the optical system working at the far-infrared waveband in a working environment of 80° C. provided by one embodiment of the present application.

FIG. 8 shows a field curve of the optical system working at the far-infrared waveband provided by an embodiment of this application.

FIG. 9 shows a distortion diagram of the optical system working at the far-infrared waveband provided by one embodiment of the present application.

FIG. 10 shows an optical architecture diagram of the optical system working at the far-infrared waveband provided by one embodiment of the present application.

FIG. 11 shows an MTF diagram of the optical system working at the far-infrared waveband provided in the first embodiment of this application.

FIG. 12 shows an MTF graph of the optical system working at the far-infrared waveband in a working environment of −40° C. provided by one embodiment of the present application.

FIG. 13 shows an MTF diagram of the far infrared optical system provided in the present one embodiment.

FIG. 14 shows a field curve of the optical system working at the far-infrared waveband provided by an embodiment of this application.

FIG. 15 shows a distortion diagram of the optical system working at the far-infrared waveband provided by one embodiment of the present application.

FIG. 16 shows an optical architecture diagram of the optical system working at the far-infrared waveband provided by one embodiment of the present application.

FIG. 17 shows an MTF diagram of the optical system working at the far-infrared waveband provided in an embodiment of this application.

FIG. 18 shows an MTF graph of the optical system working at the far-infrared waveband in a working environment of −40° C. as provided by one embodiment of the present application.

FIG. 19 shows an MTF diagram of the optical system working at the far-infrared waveband in a working environment of 80° C. provided by one embodiment of the present application.

FIG. 20 shows a field curve of the optical system working at the far-infrared waveband provided by an embodiment of this application.

FIG. 21 shows a distortion diagram of the optical system working at the far-infrared waveband provided by one embodiment of the present application.

### DETAILED DESCRIPTION OF THE EMBODIMENTS

The application is more comprehensively described below with reference to the drawings, and the embodiments are shown in the drawings. However, the present application may be implemented in many different ways and should not be construed as limited to the embodiment described herein. Instead, these embodiments are provided such that the application will be exhaustive and complete, and will fully communicate the scope of the application to those skilled in the art. The same attached drawing marks throughout indicate the same components. Furthermore, in the drawings, the thickness, ratio and size of the components are enlarged to clearly illustrate.

In addition, the described features, structures or features may be combined in one or more embodiments in any suitable manner. In the following description, many specific details are provided to give a full understanding of the exemplary embodiments of this application. However, those skilled in the art will be aware that one or more of the specific details may be omitted from the present technical solution, or other modules, groups, etc. may be adopted. In other cases, aspects of the present application are blurred without detailed showing or describing the public structure, method, implementation, or operation to avoid over-dominance.

For the optical system working at the far-infrared waveband provided by the target, the present application requires the optical system working at the far-infrared waveband to have good imaging quality when combined with an imaging detector of 640 pixels*512 pixels and an image size of 12 μm; at the same time, another performance index of the optical system is optimized as much as possible.

In the related technology, the optical system working at the far-infrared waveband which can have good imaging quality when cooperating with the imaging detector of this specification is an optical system working at the far-infrared waveband provided by the patent of CN117148547A. Specifically, the optical system working at the far-infrared waveband provided by CN117148547A uses two sulfur aspherical lenses and a metalens, and each of the front and rear surfaces contains a point of inflection. Thus, the optical system working at the far-infrared waveband provided by the patent of CN117148547A can have good imaging quality when combined with a 640 pixels*512 pixels imaging detector with an image size of 12 μm.

It should be noted that the point of inflection will increase the difficulty of lens processing, which will increase the processing cost of the optical system. Moreover, the patent of CN117148547A provides five embodiments, in each embodiment, the wavelength of the optical system working at the far-infrared waveband is 33.16 mm, 33.13 mm, 33.78 mm, 33.81 mm, and 33.79 mm, respectively, which are all greater than 33.0 mm, so there is a room for a further reduction of the total track length of the optical system working at the far-infrared waveband.

To sum up, it can be seen that the optical system working at the far-infrared waveband provided by related technology has some defects of greater difficulty in lens processing and larger total track length.

In order to overcome the above defects in the relevant technology, this application provides an optical system working at the far-infrared waveband. The optical system working at the far-infrared waveband provided by the present application can reduce the difficulty of lens processing and reduce the total length of the optical system.

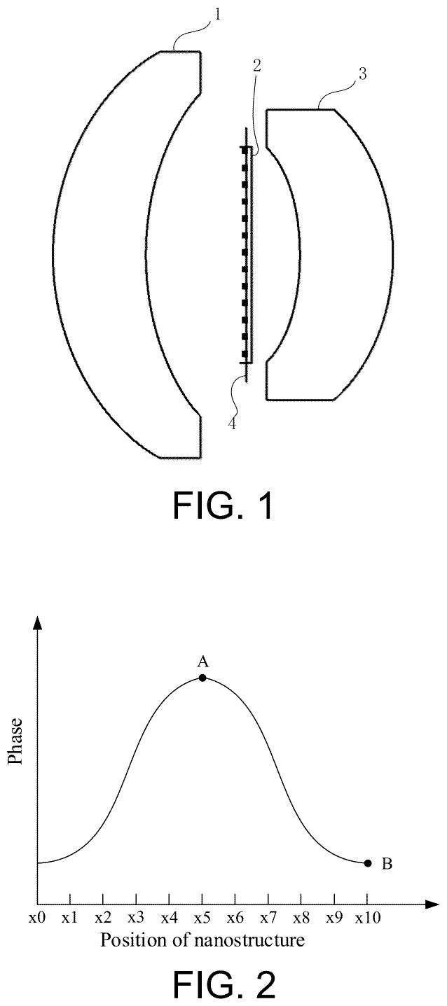

FIG. 1 shows an optical architecture diagram of the optical system working at the far-infrared waveband provided in the present application. As shown in FIG. 1, the optical system includes a first refractive lens, a metalens, and a second aspheric lens in order from an object side to an image side. Each of the first refractive lens, the metalens, and the second aspheric lens has a positive focal power.

Each of the first refractive lens, the metalens, and the second aspheric lens includes an object-side surface facing towards the object side and an image-side surface facing towards the image side. And the first refractive lens is a meniscus lens, and both the object-side surface and the image-side surface of the first refractive lens are convex to the object side. That is, the whole first refractive lens 1 is convex to the object side.

The metalens 2 includes a substrate and a plurality of unit cells located on the substrate. The vertice or/and the center of the unit cell is set with the nanostructure. The filler material filled between the nanostructures is air or other transparent materials at the working waveband.

The nanostructures may be set on the object-side surface of the metalens 2, or may be set on the image-side surface of the metalens 2.

The second aspheric lens 3 is a meniscus lens, and both the object-side surface and the image-side surface of the second aspheric lens 3 are convex to the image side. That is, the whole second aspheric lens 3 is convex to the object side.

In the optical system working at the far-infrared waveband provided by the present application, the negative dispersion of the metalens 2 will compensate for the positive dispersion of the first refractive lens 1 and the second aspheric lens 3. Therefore, the metalens 2 will correct the dispersion of the optical system effectively. Further, the metalens 2 can reduce the stress of the dispersion correction for the first refractive lens 1 and the second aspheric lens 3 effectively. Therefore, the metalens 2 can improve the degree of design freedom for the first refractive lens 1 and the second aspheric lens 3. Therefore, when the optical system working at the far-infrared waveband provided by the present application cooperates with the 640 pixels*512 pixels imaging detector with a pixel size of 12 μm, the optical system working at the far-infrared waveband provided by the present application still has good imaging quality and a total track length less than 29.0 mm.

In conclusion, in the optical system working at the far-infrared waveband provided by the present application, no lens needs to be set with a point of inflection, therefore the difficulty of lens processing has been reduced. And the metalens 2 can improve the degree of design freedom for the first refractive lens 1 and the second aspheric lens 3, therefore the total track length of the optical system working at the far-infrared waveband provided by the present application reduces.

In one embodiment, the first refractive lens 1 may be a spherical lens. In one embodiment, the first refractive lens 1 may be an aspherical lens.

In one embodiment, the second aspheric lens 3 is an even-order aspheric lens, therefore the second aspheric lens 3 has a higher degree of design freedom, which is beneficial to further correct the wavefront aberration effectively.

And when the first refractive lens is an aspheric lens, the first refractive lens is an even-aspheric lens. Therefore, the first refractive lens 1 can further have a higher degree of design freedom, which is beneficial to further correct the wavefront aberration effectively.

In one embodiment, the even-order aspheric surface of the even-aspheric len satisfies the formula as follows:

$$Z ( r ) = \frac{c {r}^{2}}{1 + \sqrt{1 - ( 1 + k ) {c}^{2} {r}^{2}}} + A {r}^{4} + B {r}^{6} + C {r}^{8} + D {r}^{10}$$

wherein r is a radius of any position of the aspheric surface in a radial direction, Z(r) is a vector height of the aspheric surface, c is a curvature of the aspheric surface, k is a conic coefficient, A is a four-order aspheric coefficient, B is a six-order aspheric coefficient, C is an eight-order aspheric coefficient, D is a ten-order aspheric coefficient.

In one embodiment, the optical system working at far-infrared waveband satisfies the condition as follows:

$$\frac{f}{D} < 1.1$$

wherein f is an effective focal length, and D is an entrance pupil diameter.

In one embodiment, f/D is an F number of the optical system working at the far-infrared waveband, the light intake of the optical system working at the far-infrared waveband is controlled at a higher level by controlling the f/D less than 1.1.

In one embodiment, the optical system working at the far-infrared waveband satisfies the condition as follows:

$$\frac{f}{D} < 0.98 .$$

In one embodiment, the optical system working at the far-infrared waveband satisfies the condition with a unit of 1/° C. as follows:

$$- 9.00 E - 05 < \frac{{n}_{a 1} * \frac{d {n}_{a 1}}{d t} * f}{{f}_{a 1}} + \frac{{n}_{a 2} * \frac{d {n}_{a 2}}{d t} * f}{{f}_{a 2}} < 9.00 E - 05$$

wherein nₐ₁ is a refractive index of the first refractive lens temperature coefficient of the first refractive lens 1;

$$\frac{{dn}_{a 1}}{df}$$

is a focal length of the first refractive lens 1; f is an effective focal length of the optical system; nₐ₂ is a refractive index of the second aspheric lens 3;

$$\frac{{dn}_{a2}}{dt}$$

is a refraction temperature coefficient of the second aspheric lens 3; fₐ₂ is a focal length of the second aspheric lens 3.

It should be noted that in the refraction temperature coefficient, t represents temperature with a unit of ° C.; the refraction temperature coefficient of the lens is used to describe the change degree of the refractive index of the lens with the changes of the temperature; and the unit of the refraction temperature coefficient is 1/° C. The larger the refraction temperature coefficient is, the change degree of the refractive index of the lens will be larger with the changes of the temperature; conversely, the smaller the refraction temperature coefficient is, the change degree of the refractive index of the lens will be less with the changes of the temperature.

It can be seen that the larger the refraction temperature coefficient of the lens is, the greater the difference between the imaging quality of the optical system at different temperatures. Therefore, the optical system cannot guarantee good imaging quality in a certain temperature range stably.

Therefore, in one embodiment, the highest value of

$$\frac{{n}_{a 1} * \frac{{dn}_{a 1}}{dt} * f}{{f}_{a 1}} + \frac{{n}_{a 2} * \frac{{dn}_{a 2}}{dt} * f}{{f}_{a 2}}$$

is configured to be 9.00E-05, and the lowest value of

$$\frac{{n}_{a 1} * \frac{{dn}_{a 1}}{dt} * f}{{f}_{a 1}} + \frac{{n}_{a 2} * \frac{{dn}_{a 2}}{dt} * f}{{f}_{a 2}}$$

is configured to be −9.00E-05. While ensuring that the first refractive lens 1 and the second aspheric lens 3 will have a reasonable focal power, the refraction temperature coefficient of the first refractive lens 1 and the refraction temperature coefficient of the second aspheric lens 3 are controlled within a small range at the same time, thus ensuring that the optical system working at the far-infrared waveband has a good imaging quality and the stability of the imaging quality within a certain temperature range.

Preferably, in one embodiment, the optical system satisfies the condition with a unit of 1/° C. as follows:

$$4. E - 05 < \frac{{n}_{a 1} * \frac{{dn}_{a 1}}{dt} * f}{{f}_{a 1}} + \frac{{n}_{a 2} * \frac{{dn}_{a 2}}{dt} * f}{{f}_{a 2}} < 8. E - 05$$

In one embodiment, the optical system working at the far-infrared waveband satisfies the condition with a unit of °/mm as follows:

$$4 < \frac{TTL * FOV}{f * BFL} < 6$$

wherein TTL is a total track length of the optical system working at the far-infrared waveband, FOV is a full field of view of the optical system working at the far-infrared waveband, f is an effective focal length of the optical system working at the far-infrared waveband, BFL is a back focal length of the optical system working at the far-infrared waveband.

In one embodiment, the unit of TTL, f and BFL is mm, and the unit of FOV is degree) (°).

The highest value of

$$\frac{TTL * FOV}{f * BFL}$$

is configured to be 6, thus avoiding the back focal length being too small. In this way, when packaging the optical camera of the optical system, the back focal region will have enough assembly space to reduce the possibility that the structural parts may interfere with each other.

And the lowest value of

$$\frac{TTL * FOV}{f * BFL}$$

is configured to be 4, thus avoiding the optical system having good imaging quality. In this way, the total track length of the optical system is further compressed.

In one embodiment, the optical system working at the far-infrared waveband satisfies the condition as follows:

$$\begin{matrix}0.1 < \vert \frac{{d}_{1} + {d}_{2}}{{R}_{1} + {R}_{2}} \vert * \frac{f}{{f}_{a 1}} < 0.6 \\ 0.1 < \vert \frac{{d}_{5} + {d}_{6}}{{R}_{5} + {R}_{6}} \vert * \frac{f}{{f}_{a2}} < 0.6\end{matrix}$$

wherein d₁ is a radius of an aperture of the object-side surface of the first refractive lens; d₂ is a radius of an aperture of the image-side surface of the first refractive lens; R₁ is a curvature radius of the object-side surface of the first refractive lens; R₂ s a curvature radius of the image-side surface of the first refractive lens; fₐ₁ is a focal length of the first refractive lens; d₅ is a radius of an aperture of the object-side surface of the second aspheric lens; d₆ is a radius of an aperture of the image-side surface of the second aspheric lens; R₅ is a curvature radius of the object-side surface of the second aspheric lens; R₆ is a curvature radius of the image-side surface of the second aspheric lens; fₐ₂ is a focal length of the second aspheric lens; f is an effective focal length of the optical system working at the far-infrared waveband.

It should be noted that the aperture of the lens refers to the effective aperture that the light can pass through effectively. That is, the distance between two edge lights at two ends in the radial direction of the lens is the diameter of the aperture of the lens.

In one embodiment,

$$\vert \frac{{d}_{1} + {d}_{2}}{{R}_{1} + {R}_{2}} \vert * \frac{f}{{f}_{a 1}}$$

is used to limit the surface type of the first refractive lens 1, and

$$\vert \frac{{d}_{5} + {d}_{6}}{{R}_{5} + {R}_{6}} \vert * \frac{f}{{f}_{a2}}$$

is used to limit the surface type of the second aspheric lens 3.

Specifically, the lowest value of

$$\vert \frac{{d}_{1} + {d}_{2}}{{R}_{1} + {R}_{2}} \vert * \frac{f}{{f}_{a 1}}$$

is configured to be 0.1, which can ensure the first refractive lens 1 has a certain focal power; the highest value of

$$\vert \frac{{d}_{1} + {d}_{2}}{{R}_{1} + {R}_{2}} \vert * \frac{f}{{f}_{a 1}}$$

is configured to be 0.6, which can avoid the focal power of the first refractive lens 1 being too large, at the same time, avoid the curvature radius of the first refractive lens 1 being too large, and avoid the processing difficulty of the first refractive lens 1 being too large.

Similarly, the lowest value of

$$\vert \frac{{d}_{5} + {d}_{6}}{{R}_{5} + {R}_{6}} \vert * \frac{f}{{f}_{a2}}$$

is configured to be 0.1, which can ensure the second aspheric lens 3 has a certain focal power; the highest value of

$$\vert \frac{{d}_{5} + {d}_{6}}{{R}_{5} + {R}_{6}} \vert * \frac{f}{{f}_{a2}}$$

is configured to be 0.6, which can avoid the focal power of the second aspheric lens 3 being too larger, and at the same time can avoid the curvature radius of the second aspheric lens 3 and the processing difficulty of the second aspheric lens 3 being too large.

In one embodiment, the optical system working at the far-infrared waveband satisfies the condition with a unit of mm/rad as follows:

$$0.01 < \frac{{d}_{m} * {f}_{m}}{φ * f} < 1.50$$

wherein dₘ is a radius of the metalens; fₘ is a focal length of the metalens; φ is a sum of the absolute values of a phase difference of a position interval of the phase curve, and the phase curve is used to describe phases at each position of the metalens in a radial direction, and the position interval of the phase curve from the center of the metalens to the edge of the metalens; f is an effective focal length of the optical system working at the far-infrared waveband.

It should be noted that in the present application, the phase curve of the metalens 2 refers to a curve used to describe in the radial direction, the phases of the nanostructures at each position.

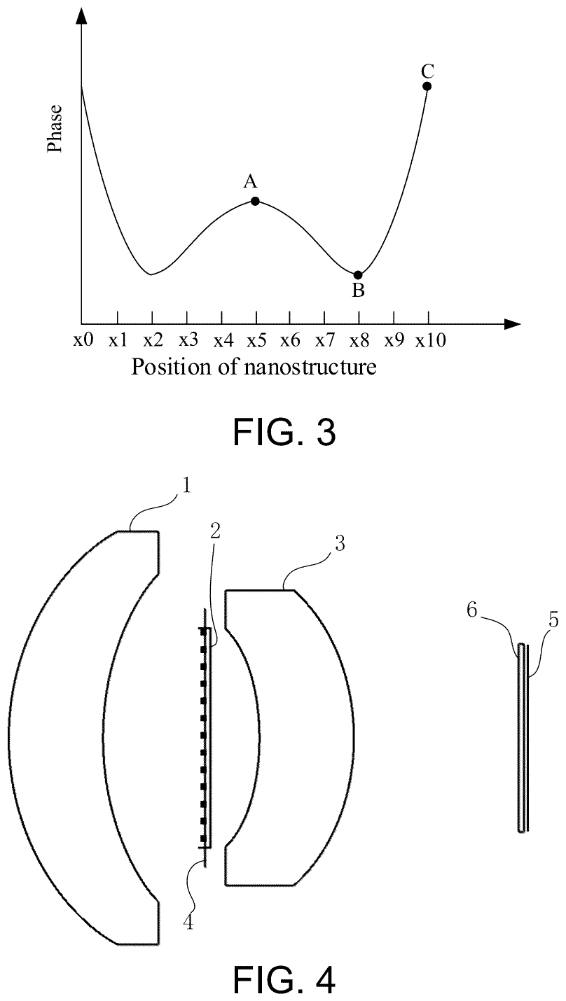

FIG. 2 shows a phase curve of the metalens 2 in one embodiment of the optical system. FIG. 3 shows a phase curve of the metalens 2 in one embodiment provided by the present application.

In FIG. 2 and FIG. 3, the horizontal axis represents the position of each nanostructure in the radial direction, and the vertical axis represents the phases provided by the corresponding nanostructures. The position x0 is central symmetrical with position x10 with respect to position x5. Therefore, in the phase curve, the position interval from position x5 to position x10 is the position interval from the center of the metalens 2 to the edge of the metalens 2.

In detail to FIG. 2, in an interval between position x5 and position x10, there is only one monotonic increase or decrease curve, that is, a monotonic increase or decrease curve segment from point A to point B. Therefore, in the embodiment of FIG. 2, an absolute value of the phase difference between point A and point B is calculated, and the corresponding φ is obtained.

In detail to FIG. 3, the interval between position x5 and position x10 includes two monotonic increase or decrease curves, that is, two monotonic increase or decrease curve segments from point A to point B. Therefore, in one embodiment of FIG. 3, an absolute value of the phase difference between point A and point B is calculated, and an absolute value of the phase difference between point C and point B is calculated. Then the two absolute values are added, and the corresponding phase φ is obtained.

Specifically, in one embodiment, the highest value of

$$\frac{{d}_{m} * {f}_{m}}{φ * f}$$

is configured to be 1.50, which can ensure that the metalens 2 has an enough focal power. In this way, the metalens 2 can correct the chromatic aberration effectively. Moreover, the lowest value of

$$\frac{{d}_{m} * {f}_{m}}{φ * f}$$

is configured to be 0.01, which can avoid the focal power of the metalens 2 being too large and the differently of processing of the nanostructures in the metalens 2 being too greater.

Preferably, in one embodiment, the optical system working at far-infrared waveband satisfies the condition with a unit of mm/rad:

$$0.02 < \frac{{d}_{m} * {f}_{m}}{φ * f} < 1.00 .$$

The optical system working at the far-infrared waveband further includes: an aperture slot, and the aperture slot is set on the object side of the metalens (that is, the aperture slot is set between the first refractive lens 1 and metalens 2, or the aperture slot is set in front of the first refractive lens 1). Therefore, the aperture slot can reduce the stray lights incident from the edge of field of view to the metalens 2. The stray lights refer to unexpected lights that the lights will reach at the image plane after propagation. In one embodiment, there may be an air gap between the aperture slot and the metalens 2. In one embodiment, the aperture slot may be set on the surface of the metalens 2.

The optical camera working at the far-infrared waveband includes an optical system working at the far-infrared waveband in any above embodiment and an imaging detector. And the imaging detector is set on an image plane 5 of the optical system working at the far-infrared waveband to receive the lights and image the lights. As shown in the optical system working at the far-infrared waveband, the details of the optical system working at the far-infrared waveband in the optical camera will not be described here.

In one embodiment, the optical system working at the far-infrared waveband further includes: a window glass. The window glass is set between the second aspheric lens 3 and the optical system working at the far-infrared waveband. The window glass is used to protect the 640 pixels*512 pixels imaging detector with a pixel size of 12 μm. In this way, the structural safety of the imaging detector improves.

TABLE 1
Target requirements for various system parameters of the
optical system working at the far-infrared waveband

| System parameters | Data | |
|---|---|---|
| Working waveband | 8~12 | μm |
| TTL (total track length) | <29.0 | mm |

| | |
|---|---|
| Field of view(2ω) | 30° |
| F number | ≤1.1 |

Table 1 shows the target requirements for various system parameters of the optical system working at the far-infrared waveband to be provided.

Specifically, in one embodiment, the target optical system working at the far-infrared waveband to be provided works at the waveband of 8-12 μm; the target total track length is less than 29.0 mm; the target full field of view is 30°; and the target F number is less than or equal to 1.1.

In the present embodiment, for the imaging quality, when the optical system working at the far-infrared waveband is required to cooperate with an imaging detector of 640 pixels*512 pixels and an image element size of 12 μm, in a room temperature, a target value MTF at a cut-off frequency within 0˜0.7 field of view is greater than or equal to 0.30; and compared with the room temperature, at a working environment of −40° C. and 80° C., a target value MTF at a cut-off frequency within 0˜0.7 field of view is greater than or equal to 0.20, and a target value MTF at a cut-off frequency within 0.7˜1 field of view is greater than or equal to 0.20.

The room temperature refers to the working environment of 20˜25° C. MTF is a Modulation Transfer Function, which is an important indicator used to describe the imaging quality of the optical system. The closer the MTF value is to the diffraction limit, the better the imaging quality, and the smaller the fluctuation value of MTF, the more stable the imaging quality.

With the target requirements shown in Table 1, the present application provides in three embodiments three optical systems working at the far-infrared waveband that meet the target requirements shown in Table 1 and the corresponding optical cameras working at the far-infrared waveband. Next, the three optical systems working at the far-infrared waveband provided in this application and the corresponding optical cameras working at the far-infrared waveband are described in detail.

### Embodiment 1

FIG. 4 shows an optical architecture diagram of the optical system working at the far-infrared waveband provided by one embodiment of the present application. As shown in FIG. 4, an optical system working at the far-infrared waveband in the present application, optical system working at the far-infrared waveband includes a first refractive lens 1, an aperture slot 4, a metalens 2, and a second aspheric lens 3 in order from an object side to an image side. The aperture slot is set on the object-side surface of the metalens 2. The nanostructures are set on the object-side surface of the metalens 2. The optical camera of the optical system including the optical system further includes a window glass 6, and the window glass 6 is set between the second aspheric lens 3 and image plane 5.

TABLE 2
Various system parameters of the optical system working
at the far-infrared waveband provided in Embodiment 1

| System parameters | Data | |
|---|---|---|
| Working waveband | 8~12 | μm |
| TTL (total track length) | 28.0 | mm |

| | |
|---|---|
| Field of view(2ω) | 30° |
| F number | 0.96 |

As shown in Table 2, the optical system working at the far-infrared waveband provided by the present application works at a target waveband of 8˜12 μm. The target total track length is less than 29.0 mm; the target full field of view is 30°; and the target F number is less than or equal to 1.1, which satisfies the requirement of light intake for the system.

From an object side to an image side, each surface of the optical system at the far-infrared waveband provided by the optical system working at the far-infrared waveband is numbered. After summarizing the parameters of each surface, Table 3 is shown below.

TABLE 3
Parameters of the various surfaces in the optical camera working
at the far-infrared waveband provided in Embodiment 1

| | | | | | Refractive |
|---|---|---|---|---|---|
| Numbered | | | | Thick- | index of |
| surface | Type of surface | Curvature radius | | ness | material |
| 1 | Aspheric surface | 14.300 | mm | 5.02 mm | 2.78 |
| 2 | Aspheric surface | 16.000 | mm | — | — |
| 3 | Aperture slot | Infinite | | 0.00 mm | — |
| 4 | Structural | Infinite | | 0.30 mm | 3.42 |
| | surface | | | | |
| | (metalens) | | | | |
| 5 | Spherical surface | Infinite | | 2.60 mm | — |
| 6 | Aspheric surface | −14.000 | mm | 5.03 mm | 2.78 |
| 7 | Aspheric surface | −12.400 | mm | 8.78 mm | — |

| | | | | |
|---|---|---|---|---|
| 8 | Spherical surface | Infinite | 0.30 mm | 3.42 |
| 9 | Spherical surface | Infinite | 0.20 mm | — |
| 10 | Image plane | Infinite | — | — |

The surface 1 is an object-side surface of the first refractive lens 1. The surface 2 is an image-side surface of a first refractive lens 1. The surface 3 is an aperture slot. The surface 4 is object-side surface of the metalens 2, and the nanostructures are set on the surface 4 in the present application, that is, the surface 4 is recorded as a structural surface (metalens). The surface 5 is an image-side surface of the metalens 2. The surface 6 is an object-side surface of the second aspheric lens 3. The surface 7 is an image-side surface of the second aspheric surface 3. The surface 8 is an object-side surface of the window glass. The surface 9 is an image-side surface of the window glass 6. The surface 10 is an image plane 5.

It can be seen from Table.3 that the surface 1 is an aspheric surface with a curvature radius of 14.30 mm and the distance between the surface 1 and the surface 2 is 5.02 mm, and the refractive index of the filler material filled between the surface 1 and the surface 2 is 2.78. The surface 2 is the aspheric surface with a curvature radius of 16.000 mm, and the distance between the surface 2 and surface 3 is 5.41 mm. There is air set between the surface 3 and surface 2. The surface 3 is the aspheric surface with the infinite curvature radius (that is, the aspheric surface is plane). The distance between the surface 3 and surface 4 is 0 (that is, the surface 3 and surface 4 are co-planar), and the no filler material is filled between the surface 3 and surface 4. The surface 4 is a plane, and the distance between the surface 4 and surface 5 is 0.30 mm. The refractive index of the material between the surface 4 and surface 5 is 3.42. The surface 5 is a plane, and the distance between the surface 5 and the surface 6 is 2.60 mm. There is air set between the surface 5 and surface 6. The surface 6 is an aspheric surface with a curvature radius of −14.000 mm, and the distance between the surface 6 and surface 7 is 5.03 mm. The refractive index of the material between the surface 6 and surface 7 is 2.78. The surface 7 is an aspheric surface with a curvature radius of −12.400 mm. The distance between the surface 7 and surface 8 is 8.78 mm, there is air between the surface 7 and surface 8. The surface 8 is a plane, and the distance between the surface 8 and surface 9 is 0.30 mm. And the refractive index of the material between the surface 8 and surface 9 is 3.42. The surface 9 is a plane, and the distance between the surface 9 and surface 10 is 0.20 mm. There is air set between the surface 9 and surface 10. The surface 10 is a plane.

After summarizing the parameters of each aspherical surface in the optical system working at the far-infrared waveband provided in this embodiment, Table 4 as shown below is obtained.

TABLE 4
Parameters of each aspheric surface in the optical system
working at far-infrared waveband provided in Embodiment 1

| Numbered | | | | | |
|---|---|---|---|---|---|
| surface | k | A | B | C | D |
| 1 | 4.780E−01 | −1.218E−06 | 2.186E−07 | −1.051E−08 | 2.398E−10 |
| 2 | 6.430E−01 | 2.905E−05 | −6.850E−07 | 1.490E−08 | −1.657E−10 |
| 6 | 3.080E+00 | −2.604E−04 | 1.294E−05 | −1.529E−06 | 9.710E−08 |
| 7 | 2.280E+00 | −2.040E−04 | −2.564E−06 | −1.241E−08 | 3.081E−10 |

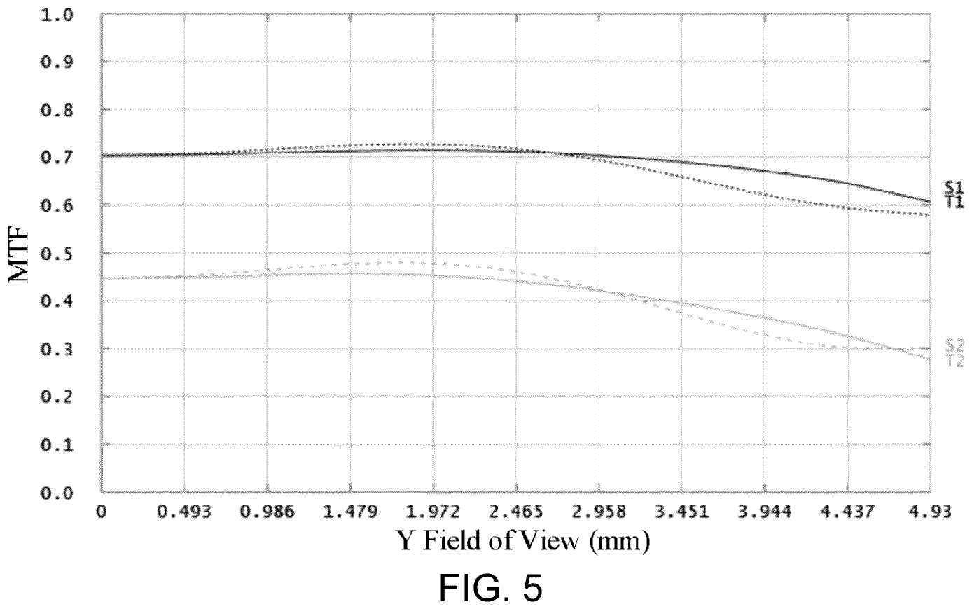

FIG. 5 shows an MTF diagram of the optical system working at the far-infrared waveband provided by Embodiment 1. The horizontal axis of FIG. 5 represents the field of view in the Y axis direction; the vertical axis represents the MTF value. In FIG. 5, T represents the curve in the meridional direction, S represents the curve in the sagittal direction; the meridional curve T₁ and the sagittal curve S₁ correspond to the spatial frequency 21.001p/mm (line pair/mm), and the meridional curve T₂ and the sagittal curve S₂ correspond to the cut-off frequency 42.001p/mm.

As can be seen from FIG. 5, the MTF value at the cut-off frequency in the range of 0˜0.7 fields of view (that is, in the range of 0 to 3.451 mm) is always greater than 0.38, that is, is greater than 0.30 specified by the target. This shows that the imaging quality of the optical system working at the far-infrared waveband is good under a room-temperature working environment.

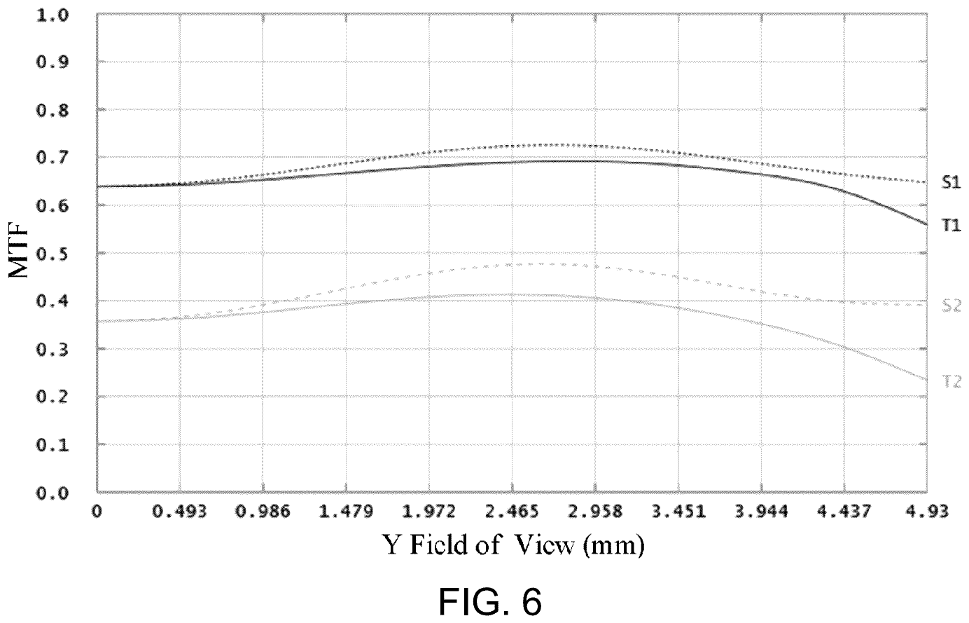

FIG. 6 shows an MTF diagram of the optical system working at the far-infrared waveband in a working environment of −40° C. as provided in Embodiment 1. As for the description of the meaning of the horizontal and vertical axis of FIG. 5 and the meaning of the curve, the meaning of the horizontal axis and vertical axis of the curve will not be repeated here.

It can be seen in FIG. 5 and FIG. 6 that compared with the room temperature, when the optical system works at the working environment of −40° C., the fluctuation value of the MTF at 0˜0.7 fields of view is less than 0.06; and when the optical system works at the working environment of −40° C., the fluctuation value of the MTF at 0.7˜1 fields of view (that is, in a range of 3.451 mm˜4.93 mm) is less than 0.04, that is, is less than the highest value of target MTF of 0.20. Therefore, at the working environment of −40° C., the optical system working at the far-infrared waveband has a good imaging quality. The horizontal axes of FIG. 5 and FIG. 6 are Y field of view, and they use imaging height to measure the field of view.

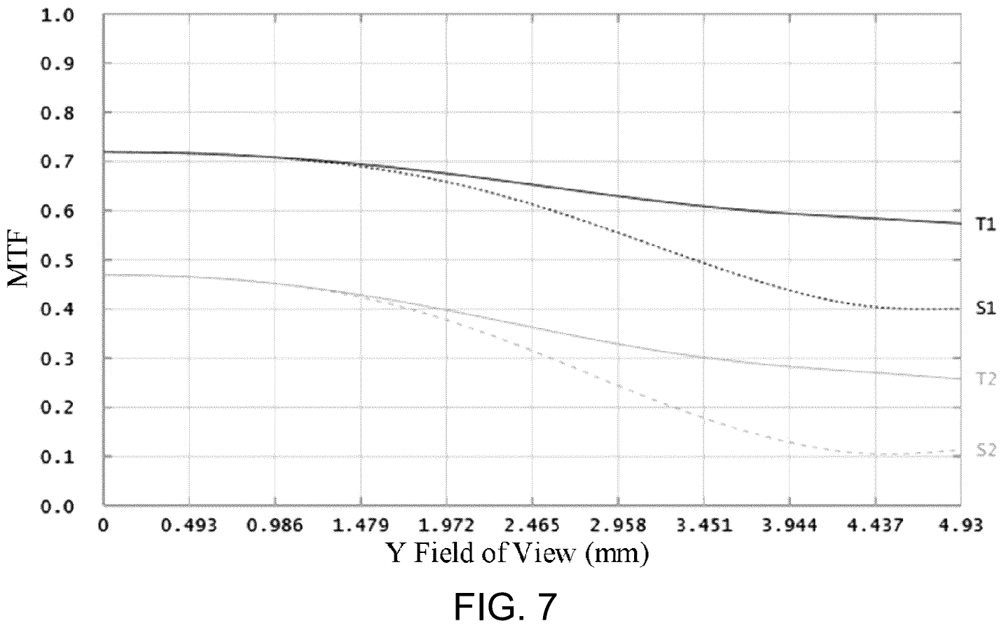

FIG. 7 shows an MTF curve of the optical system working at the far-infrared waveband provided by embodiment 1 at the working environment of 80° C. Similarly, for the description of the meaning of the horizontal and vertical axis of FIG. 5 and the meaning of the curve, the meaning of the horizontal and vertical axis of the curve will not be repeated here. The horizontal axis of FIG. 7 is the Y field of view, and it uses imaging height to measure the field of view.

As can be seen from FIG. 5 to FIG. 7, the optical system working at the far-infrared waveband always maintains a good imaging quality in the temperature range of −40° C.˜80° C. This shows that the optical system working at the far-infrared waveband fully realizes the passive athermalization.

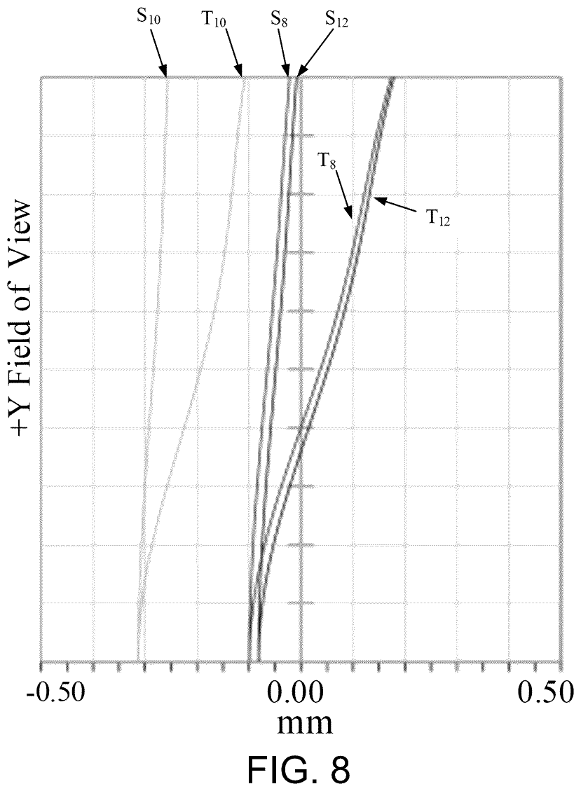

FIG. 8 shows a field curve diagram of the optical system working at the far-infrared waveband provided by embodiment 1. The horizontal axis in FIG. 8 represents the distance deviation between the actual focal point and the image plane, and the distance deviation has a unit in mm. The vertical axis represents the field of view in the positive direction along the Y axis. In FIG. 8, T₈ represents the field curve at the wavelength of 8 μm in the meridional direction, S& represents the field curve in the sagittal direction at the wavelength of 8 μm, T₁₀ represents the field curve at the wavelength of 10 μm in the meridional direction, S₁₀ represents the field curve at of wavelength of 10 μm in the sagittal direction, T₁₂ represents the field curve at wavelength of 12 μm in the meridional direction, and S₁₂ represents the field curve at the wavelength of 12 μm in the sagittal direction.

As can be seen from FIG. 8, for the optical system working at the waveband of 8-12 μm, the maximum meridional field curve is about 0.21 mm, and the maximum sagittal field curve is 0.06 mm. This shows that the field curvature of the optical system working at the far-infrared waveband is very small.

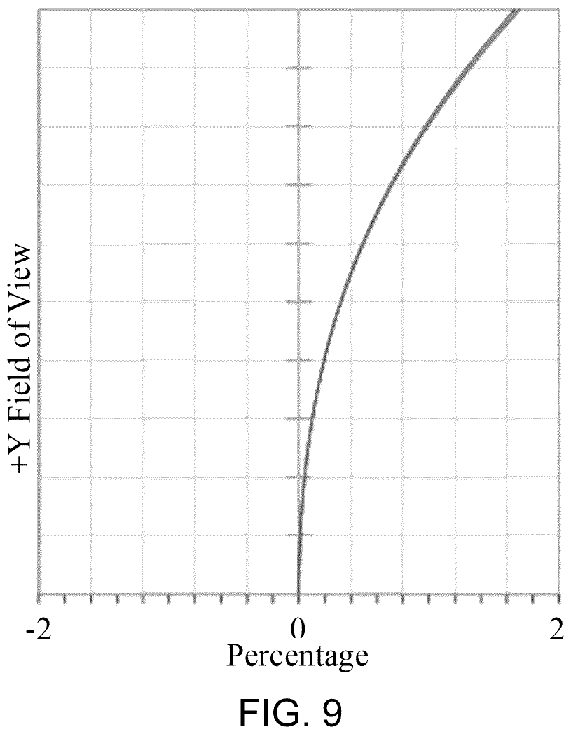

FIG. 9 shows a distortion diagram of the optical system working at the far-infrared waveband in embodiment 1. The horizontal axis of FIG. 9 represents the distortion degree of imaging with a unit of percentage; the vertical axis of FIG. 9 represents a field of view along the positive direction of Y axis. FIG. 9 shows the distortion curves at the three wavelengths of 8 μm, 10 μm and 12 μm. Because the three distortion curves are too close and almost exactly coincide.

It can be seen in FIG. 9, at each wavelength of waveband of 8˜12 μm, the distortion of the optical system working at the far-infrared waveband is less than 1.8%. Therefore, the distortion of the optical system working at the far-infrared waveband is very small.

### Embodiment 2

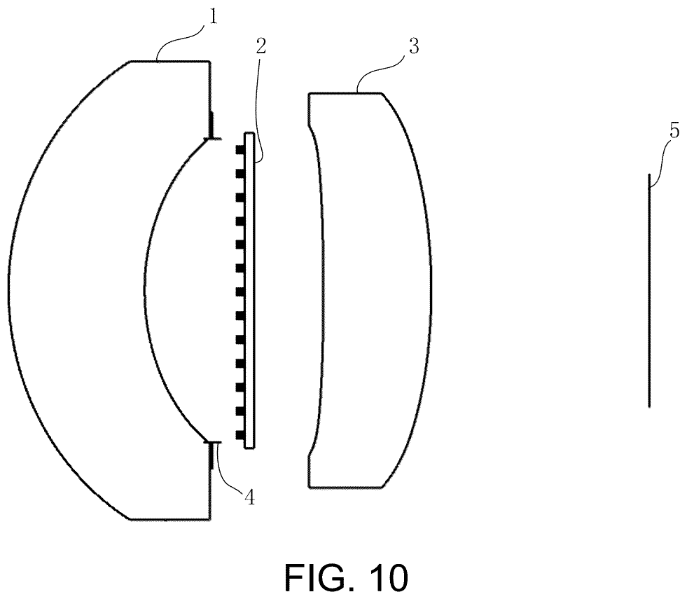

FIG. 10 shows an optical architecture diagram of the optical system working at the far-infrared waveband provided by embodiment 2 of the present application. As shown in FIG. 10, an optical system working at the far-infrared waveband in the present application, optical system working at the far-infrared waveband includes a first refractive lens 1, an aperture slot 4, a metalens 2, and a second aspheric lens 3 in order from an object side to an image side. The aperture slot is set on the object-side surface of the metalens 2. The nanostructures are set on the object-side surface of the metalens 2.

TABLE 5
Various system parameters of the optical system working
at the far-infrared waveband provided in Embodiment 2

| System parameters | Data | |
|---|---|---|
| Working waveband | 8~12 | μm |
| TTL (total track length) | 27.7 | mm |

| | |
|---|---|
| Field of view(2ω) | 30° |
| F number | 0.99 |

As shown in Table 5, the optical system working at the far-infrared waveband provided by the present application works at a target waveband of 8˜12 μm. The target total track length is less than 27.7 mm; the target full field of view is 30°; and the target F number is less than or equal to 0.99, which satisfies the requirement of light intake for the system.

From an object side to an image side, each surface of the optical system at the far-infrared waveband provided by the optical system working at the far-infrared waveband is numbered. After summarizing the parameters of each surface, Table 6 is shown below.

TABLE 6
Parameters of the various surfaces in the optical camera working
at the far-infrared waveband provided in Embodiment 2

| | | | | | Refractive |
|---|---|---|---|---|---|
| Numbered | | | | Thick- | index of |
| surface | Type of surface | Curvature radius | | ness | material |
| 1 | Aspheric surface | 12.395 | mm | 5.889 mm | 2.78 |
| 2 | Aspheric surface | 10.120 | mm | 2.935 mm | — |
| 3 | Aperture slot | Infinite | | 1.405 mm | — |
| 4 | Structural | Infinite | | 0.400 mm | 3.42 |
| | surface | | | | |
| | (metalens) | | | | |
| 5 | Spherical surface | Infinite | | 2.994 mm | — |
| 6 | Aspheric surface | −90.132 | mm | 4.669 mm | 2.78 |
| 7 | Aspheric surface | −24.916 | mm | 9.441 mm | — |

| | | | |
|---|---|---|---|
| 8 | Image surface | Infinite | — |

Similar to the description of Table 3, Table 6 will not be described here.

After summarizing the parameters of each aspherical surface in the optical system working at the far-infrared waveband provided in this embodiment, Table 7 as shown below is obtained.

TABLE 7
Parameters of each aspheric surface in the optical system
working at far-infrared waveband provided in Embodiment 2

| Numbered | | | | | |
|---|---|---|---|---|---|
| surface | k | A | B | C | D |
| 1 | 1.613E−01 | −2.097E−07 | −8.286E−08 | 4.336E−09 | −7.942E−11 |
| 2 | 7.243E−01 | −1.051E−05 | −9.355E−07 | 8.076E−08 | −2.211E−09 |
| 6 | 6.210E+01 | −1.633E−05 | −1.815E−06 | 8.287E−08 | −9.279E−10 |
| 7 | 6.348E+00 | −4.449E−06 | 1.004E−06 | −3.184E−08 | 3.357E−10 |

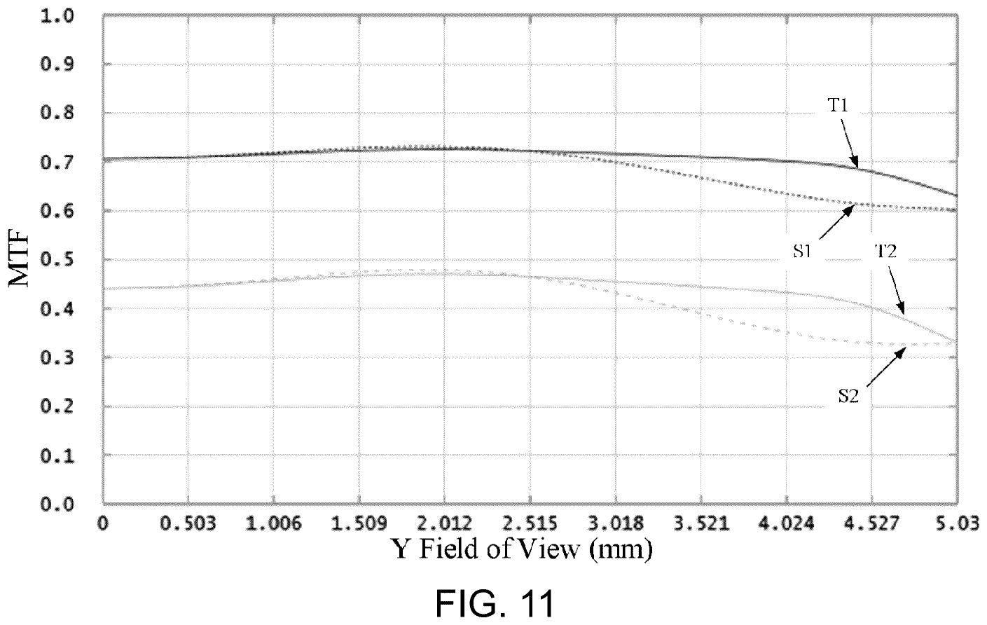

FIG. 11 shows the MTF diagram of the optical system working at the far-infrared waveband provided by embodiment 2 in a room-temperature working environment. In the same way, for the description of the horizontal and vertical axis of FIG. 5 and the description of each curve, the description of the horizontal and vertical axis and the description of each curve of FIG. 11 will not be repeated here.

As can be seen from FIG. 11, the MTF value at the cut-off frequency in the range of 0˜0.7 fields of view (that is, in the range of 0˜3.521 mm) is always greater than 0.38, that is, is greater than 0.30 specified by the target. This shows that the imaging quality of the optical system working at the far-infrared waveband is good under a room-temperature working environment.

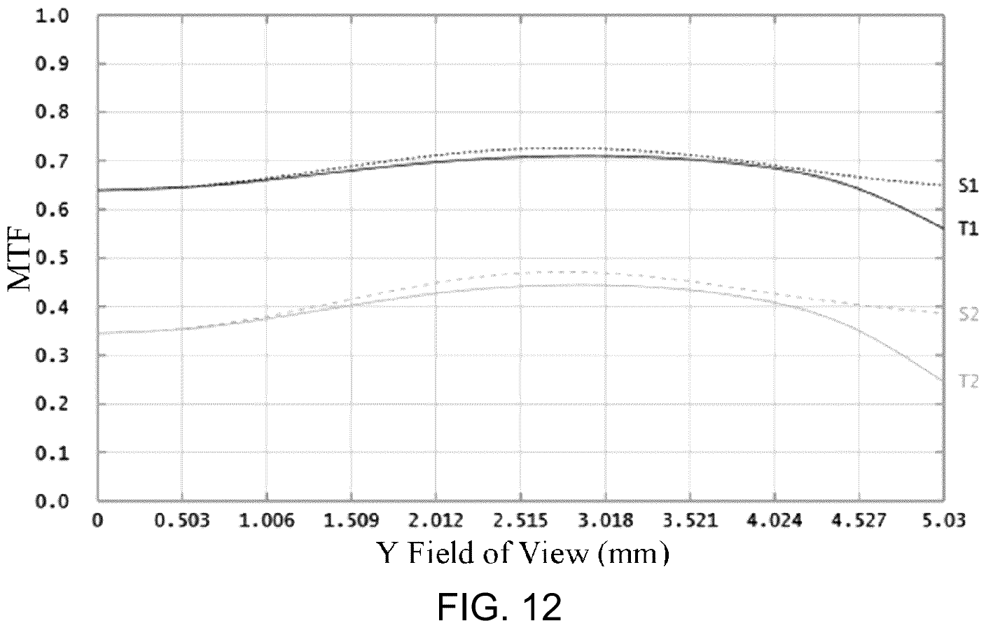

FIG. 12 shows an MTF diagram of the optical system working at the far-infrared waveband in a working environment of −40° C. as provided in embodiment 2. As for the description of the meaning of the horizontal and vertical axis of FIG. 5 and the meaning of the curve, the meaning of the horizontal and vertical axis of the curve of FIG. 12 will not be repeated here.

It can be seen in FIG. 11 and FIG. 12 that compared with the room temperature, when the optical system works at the working environment of −40° C., the fluctuation value of the MTF at 0˜0.7 fields of view is less than 0.03; and when the optical system works at the working environment of −40° C., the fluctuation value of the MTF at 0.7˜1 fields of view (that is, in a range of 3.521 mm˜5.03 mm) is less than 0.08, that is, is less than the highest value of target MTF of 0.20. Therefore, at the working environment of −40° C., the optical system working at the far-infrared waveband has a good imaging quality.

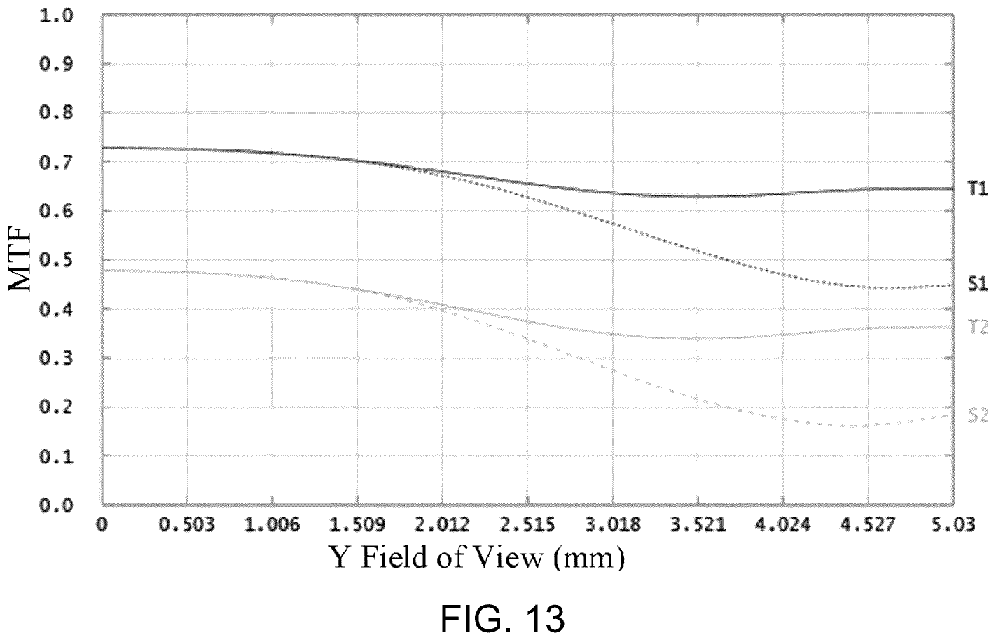

FIG. 13 shows an MTF curve of the optical system working at the far-infrared waveband provided by embodiment 2 at the working environment of 80° C. Similarly, for the description of the meaning of the horizontal and vertical axis of FIG. 5 and the meaning of the curve, the meaning of the horizontal and vertical axis of the curve of FIG. 13 will not be repeated here

As can be seen from FIG. 11 to FIG. 13, the optical system working at the far-infrared waveband always maintains a good imaging quality in the temperature range of −40° C.˜80° C. This shows that the optical system working at the far-infrared waveband fully realizes the passive athermalization.

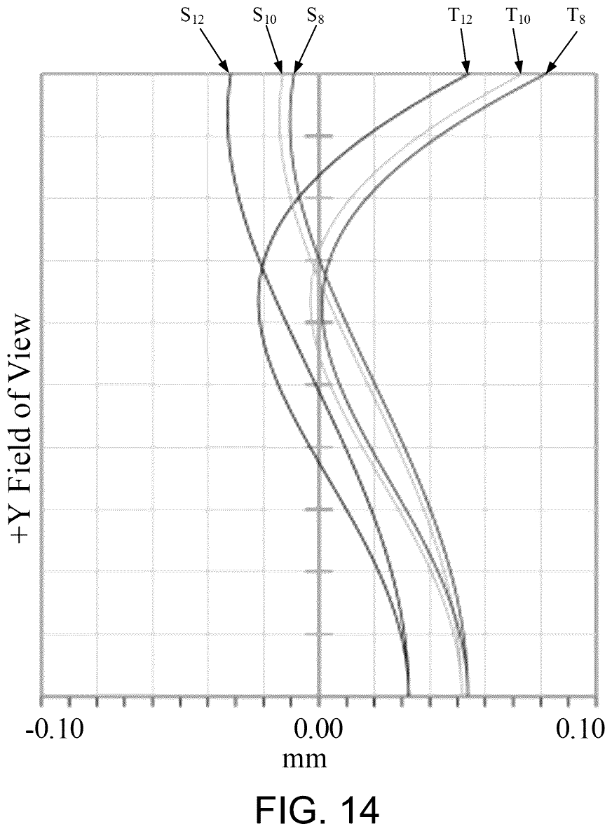

As can be seen from FIG. 14, for the optical system working at the waveband of 8-12 μm, the maximum meridional field curve is about 0.08 mm, and the maximum sagittal field curve is 0.07 mm. This shows that the field curvature of the optical system working at the far-infrared waveband is very small.

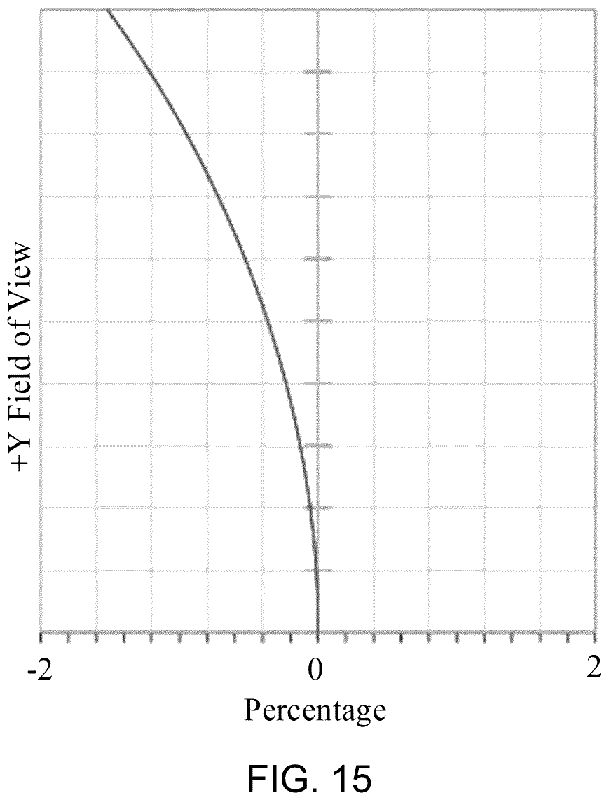

FIG. 15 shows a distortion diagram of the optical system working at the far-infrared waveband in embodiment 2. In the same way, for the meaning of the horizontal and vertical axis of FIG. 9 and the meaning of each curve, the meaning of the horizontal and vertical axis and the meaning of each curve will not be repeated here.

It can be seen in FIG. 15, at each wavelength of waveband of 8˜12 μm, the distortion of the optical system working at the far-infrared waveband is less than 1.6%. Therefore, the distortion of the optical system working at the far-infrared waveband is very small.

### Embodiment 3

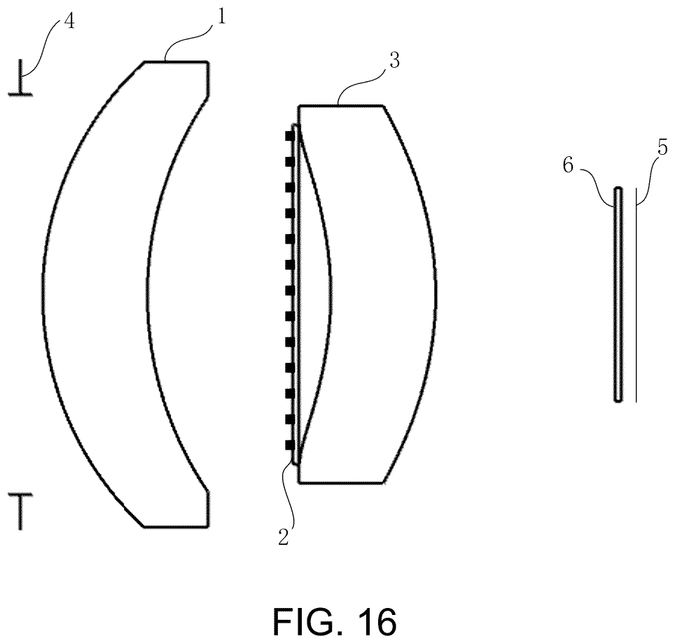

FIG. 16 shows an optical architecture diagram of the optical system working at the far-infrared waveband provided by embodiment 3 of the present application. As shown in FIG. 16, an optical system working at the far-infrared waveband in the present application, optical system working at the far-infrared waveband includes a first refractive lens 1, an aperture slot 4, a metalens 2, and a second aspheric lens 3 in order from an object side to an image side. The aperture slot 4 is set on the object-side surface of the metalens 2. The nanostructures are set on the object-side surface of the metalens 2. The optical camera of the optical system including the optical system further includes a window glass 6, and the window glass 6 is set between the second aspheric lens 3 and image plane 5.

TABLE 8
Various system parameters of the optical system working
at the far-infrared waveband provided in Embodiment 3

| System parameters | Data | |
|---|---|---|
| Working waveband | 8~12 | μm |
| TTL (total track length) | 28.7 | mm |

| | |
|---|---|
| Field of view(2ω) | 30° |
| F number | 0.99 |

As shown in Table 8, the optical system working at the far-infrared waveband provided by the present application works at a target waveband of 8˜12 μm. The target total track length is less than 28.7 mm, which is less than the highest value of target TTL of 29.00 mm; the target full field of view of the optical system working at the far-infrared waveband is 30°; and the target F number is 0.99, which is less than the highest value of target F number and satisfies the requirement of light intake for the system.

From an object side to an image side, each surface of the optical system at the far-infrared waveband provided by the optical system working at the far-infrared waveband is numbered. After summarizing the parameters of each surface, Table 9 is shown below.

TABLE 9
Parameters of the various surfaces in the optical camera working
at the far-infrared waveband provided in Embodiment 3

| | | | | | Refractive |
|---|---|---|---|---|---|
| Numbered | | | | Thick- | index of |
| surface | Type of surface | Curvature radius | | ness | material |
| 1 | Aperture slot | Infinite | | 1.071 mm | — |
| 2 | Spherical surface | 15.069 | mm | 4.991 mm | 2.78 |
| 3 | Spherical surface | 16.708 | mm | 6.925 mm | — |
| 4 | Structural | Infinite | | 0.300 mm | 3.42 |
| | surface | | | | |
| | (metalens) | | | | |
| 5 | Spherical surface | Infinite | | 1.516 mm | — |
| 6 | Aspheric surface | −15.856 | mm | 5.001 mm | 2.78 |
| 7 | Aspheric surface | −15.801 | mm | 8.550 mm | — |

| | | | | |
|---|---|---|---|---|
| 8 | Spherical surface | Infinite | 0.300 mm | 3.42 |
| 9 | Spherical surface | Infinite | 0.200 mm | — |
| 10 | Image plane | Infinite | — | — |

Similar to the description of Table 3, Table 9 will not be described here.

After summarizing the parameters of each aspherical surface in the optical system working at the far-infrared waveband provided in this embodiment, Table 10 as shown below is obtained.

TABLE 10
Parameters of each aspheric surface in the optical system
working at far-infrared waveband provided in Embodiment 3

| Surface | | | | | |
|---|---|---|---|---|---|
| numbered | k | A | B | C | D |
| 6 | 2.050E+00 | 2.400E−04 | −1.851E−06 | −1.421E−09 | 5.383E−10 |
| 7 | 1.340E+01 | −2.401E−04 | 3.843E−06 | −8.017E−08 | 1.147E−09 |

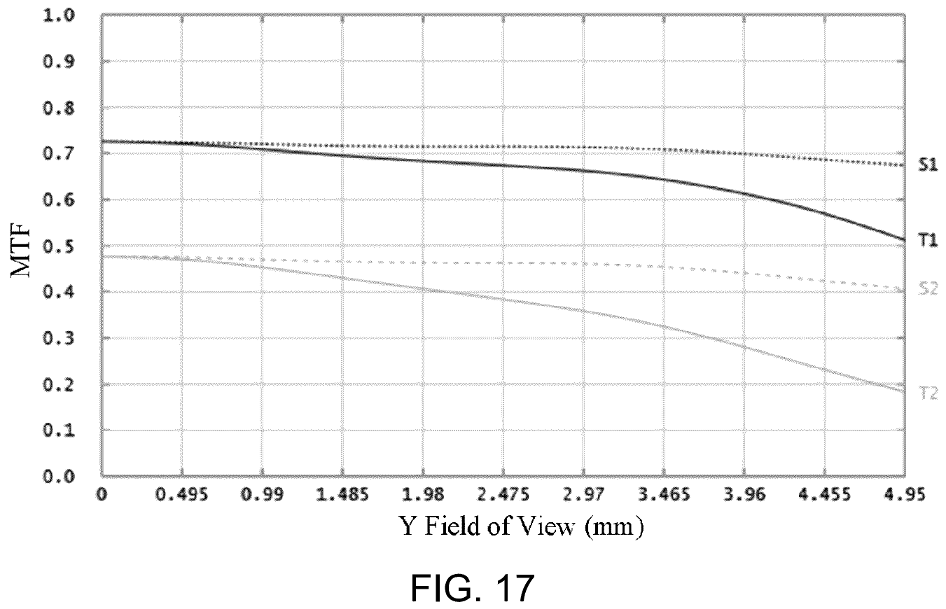

FIG. 17 shows the MTF diagram of the optical system working at the far-infrared waveband provided by embodiment 3 in a room-temperature working environment. In the same way, for the description of the horizontal and vertical axis of FIG. 5 and the description of each curve, the description of the horizontal and vertical axis and the description of each curve of FIG. 17 will not be repeated here.

As can be seen from FIG. 17, the MTF value at the cut-off frequency in the range of 0˜0.7 fields of view (that is, in the range of 0˜3.465 mm) is always greater than 0.32, that is, is greater than 0.30 specified by the target. This shows that the imaging quality of the optical system working at the far-infrared waveband is good under a room-temperature working environment.

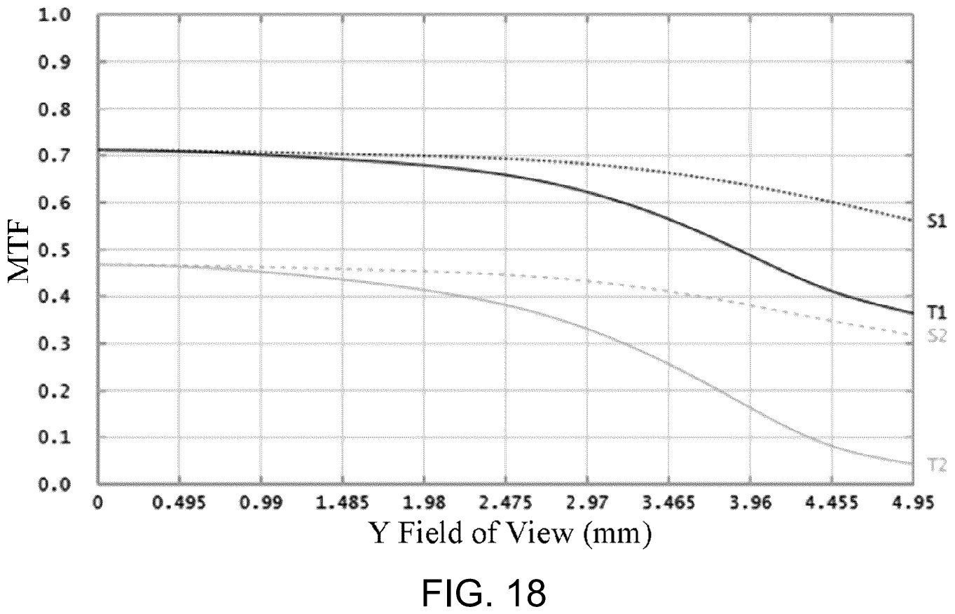

FIG. 18 shows an MTF diagram of the optical system working at the far-infrared waveband in a working environment of −40° C. as provided in embodiment 3. As for the description of the meaning of the horizontal and vertical axis of FIG. 5 and the meaning of the curve, the meaning of the horizontal and vertical axis of the curve of FIG. 18 will not be repeated here.

It can be seen in FIG. 17 and FIG. 18 that compared with the room temperature, when the optical system works at the working environment of −40° C., the fluctuation value of the MTF at 0˜0.7 fields of view is less than 0.07; and when the optical system works at the working environment of −40° C., the fluctuation value of the MTF at 0.7˜1 fields of view (that is, in a range of 3.465 mm˜4.95 mm) is less than 0.13, that is, is less than the highest value of target MTF of 0.20. Therefore, at the working environment of −40° C., the optical system working at the far-infrared waveband has a good imaging quality.

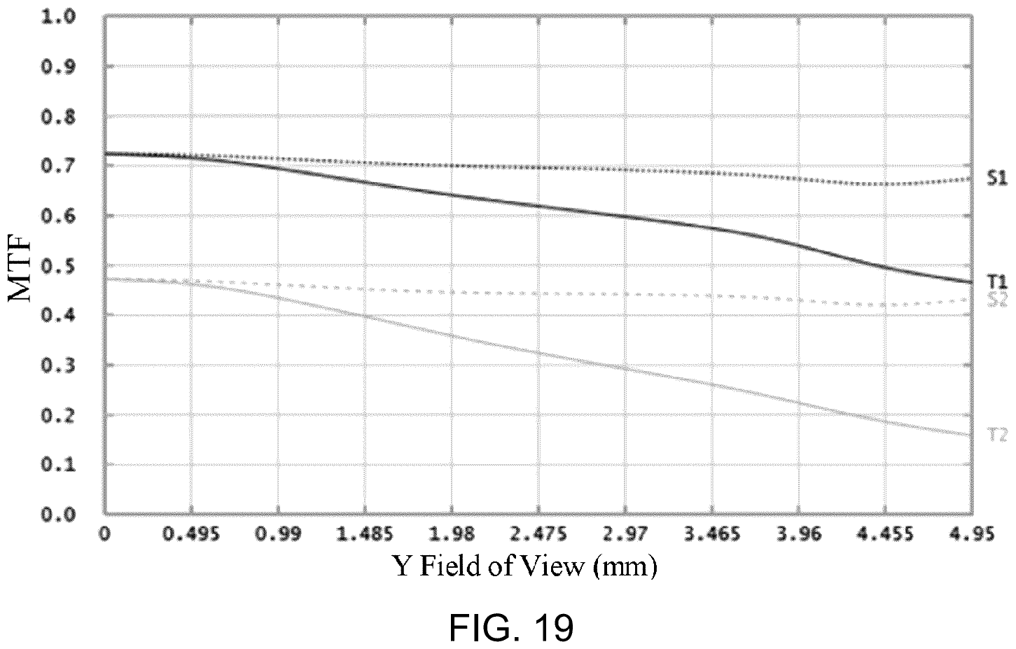

FIG. 19 shows an MTF curve of the optical system working at the far-infrared waveband provided by embodiment 3 at the working environment of 80° C. Similarly, for the description of the meaning of the horizontal and vertical axis of FIG. 5 and the meaning of the curve, the meaning of the horizontal and vertical axis of the curve of FIG. 19 will not be repeated here

As can be seen from FIG. 17 to FIG. 19, compared with the room-temperature working environment, in the working environment of 80° C., the fluctuation value of MTF is less than 0.06, and the fluctuation value of the MTF value at the 0˜0.7 fields of view is less than 0.06, that is, the MTF value at the 0˜0.7 fields of view is less than the highest value of target MTF of 0.20. This shows that the imaging quality of the optical system working at the far-infrared waveband is good in the working environment of 80° C.

As can be seen from FIG. 17 to FIG. 19, the optical system working at the far-infrared waveband always maintains a good imaging quality in the temperature range of −40° C.˜80° C. This shows that the optical system working at the far-infrared waveband fully realizes passive athermalization.

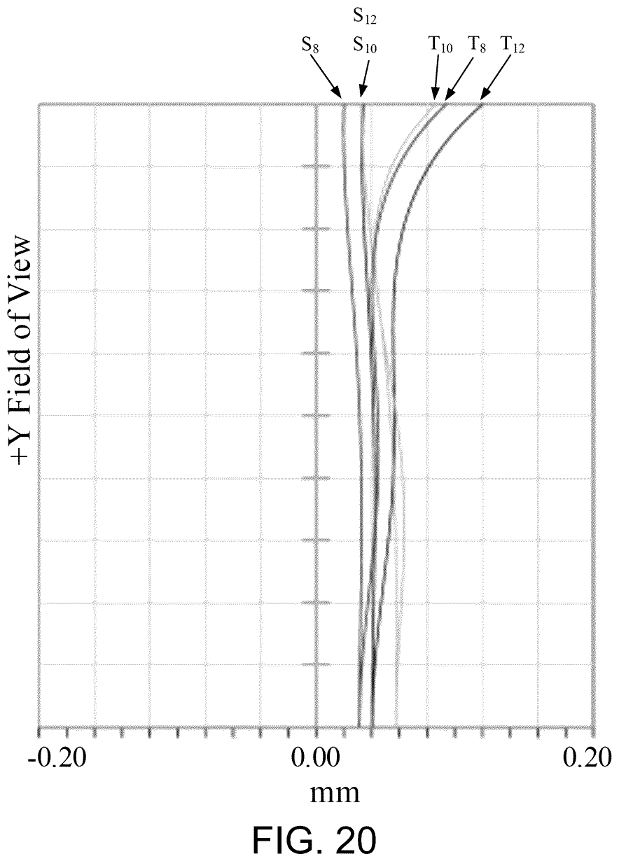

FIG. 20 shows a field curve diagram of the optical system working at the far-infrared waveband in embodiment 3. In the same way, similar to the meaning of the horizontal axis and vertical axis of FIG. 8 and the meaning of each curve, the meaning of the horizontal and vertical axis and the meaning of each curve of FIG. 20 will not be repeated here.

As can be seen from FIG. 20, for the optical system working at the waveband of 8-12 μm, the maximum meridional field curve is about 0.03 mm, and the maximum sagittal field curve is 0.08 mm. This shows that the field curvature of the optical system working at the far-infrared waveband is very small.

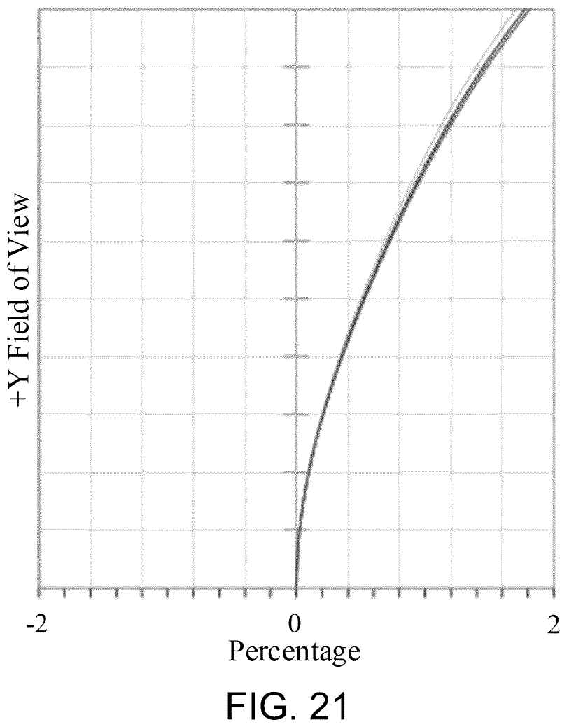

FIG. 21 shows a distortion diagram of the optical system working at the far-infrared waveband in embodiment 3. In the same way, for the meaning of the horizontal and vertical axis of FIG. 8 and the meaning of each curve, the meaning of the horizontal and vertical axis and the meaning of each curve of FIG. 21 will not be repeated here.

It can be seen in FIG. 21 that at each wavelength of the waveband of 8˜12 μm, the distortion of the optical system working at the far-infrared waveband is less than 1.8%. Therefore, the distortion of the optical system working at the far-infrared waveband is very small.

After summarizing the various parameters of each aspherical surface in the optical system working at the far-infrared waveband provided by the above three embodiments, Table 11 is shown below. The displays in Table 11 are mainly used to explain the conditions met by the optical system working the far-infrared waveband provided in this application, and are experimentally verified and supported.

TABLE 11
The various parameters of the far-infrared optical system
provided by the respective embodiments

| Condition | Embodiment 1 | Embodiment 2 | Embodiment 3 |
|---|---|---|---|
| f | 18.3 mm | 19.0 mm | 18.8 mm |
| D | 19 mm | 19.2 mm | 19 mm |
| nₐ₁ | 2.78 | 2.78 | 2.78 |
| $\frac{{dn}_{a 1}}{dt}$ | 18 × 10−6/° C. | 18 × 10−6/° C. | 18 × 10−6/° C. |
| nₐ₂ | 2.78 | 2.78 | 2.78 |
| $\frac{{dn}_{a 2}}{dt}$ | 18 × 10−6/° C. | 18 × 10−6/° C. | 18 × 10−6/° C. |
| fₐ₁ | 26 mm | 47.7 mm | 29.3 mm |
| fₐ₂ | 20.5 mm | 17.9 mm | 43.3 mm |
| TTL | 28.0 mm | 27.7 mm | 28.7 mm |
| 1FOV | 30° | 30° | 30° |
| 1BFL | 9.25 mm | 9.45 mm | 9 mm |
| d₁ | 11 mm | 9.9 mm | 11 mm |
| d₂ | 8.7 mm | 6.6 mm | 9.4 mm |
| R₁ | 14.300 mm | 12.395 mm | 15.069 mm |
| R₂ | 16.000 mm | 10.120 mm | 16.708 mm |
| d₅ | 5.8 mm | 7.1 mm | 8.1 mm |
| d₆ | 7.9 mm | 8.5 mm | 9 mm |
| 1R₅ | −14.000 mm | −90.132 mm | −15.856 mm |
| 1R₆ | −12.400 mm | −24.916 mm | −15.801 mm |
| dₘ | 5.8 mm | 6.8 mm | 8 mm |
| lfₘ | 92.9 | 102 mm | 28.8 mm |
| φ | 35 | 38 | 573 |
| $\frac{f}{D}$ | 0.96 | 0.99 | 0.99 |
| $\frac{{n}_{a 1} * \frac{{dn}_{a 1}}{dt} * f}{{f}_{a 1}} +$ | 7.99E−05 (1/° C.) | 7.30E−05 (1/° C.) | 5.38E−05 (1/° C.) |
| $\frac{{n}_{a 2} * \frac{{dn}_{a 2}}{dt} * f}{{f}_{a 2}}$ | | | |
| $\frac{TTL * FOV}{f * BFL}$ | 4.96 (°/mm) | 4.63 (°/mm) | 5.09 (°/mm) |
| $\vert \frac{{d}_{1} + {d}_{2}}{{R}_{1} + {R}_{2}} \vert * \frac{f}{{f}_{a 1}}$ | 0.458 | 0.292 | 0.412 |
| $\vert \frac{{d}_{5} + {d}_{6}}{{R}_{5} + {R}_{6}} \vert * \frac{f}{{f}_{a 2}}$ | 0.463 | 0.144 | 0.234 |
| $\frac{{d}_{m} * {f}_{m}}{φ * f}$ | 0.841 (mm/rad) | 0.961 (mm/rad) | 0.021(mm/rad) |

The above is only a specific embodiment of the embodiments of this disclosure, but the scope of protection of the embodiment of this disclosure is not limited to this. And those skilled in the field can easily think of any change or substitution for this disclosure, which should be covered within the protection scope of this disclosure. Therefore, the scope of the protection of the present disclosure shall be the scope of the claims.

What is claimed is:

1. An optical system working at a far-infrared waveband, comprising a first refractive lens, a metalens, and a second aspheric lens in order from an object side to an image side;
wherein, each of the first refractive lens, the metalens, and the second aspheric lens has a positive focal power;
each of the first refractive lens, the metalens, and the second aspheric lens comprises an object-side surface facing towards the object side and an image-side surface facing towards the image side;
the first refractive lens is a meniscus lens, and both the object-side surface and the image-side surface of the first refractive lens are convex to the object side;
the second aspheric lens is a meniscus lens, and both the object-side surface and the image-side surface of the second aspheric lens are convex to the image side.

2. The optical system working at the far-infrared waveband according to claim 1, wherein the first refractive lens is a spherical lens.

3. The optical system working at the far-infrared waveband according to claim 1, wherein the first refractive lens is an aspherical lens.

4. The optical system working at the far-infrared waveband according to claim 3, wherein the second aspheric lens is an even-order aspheric lens; and when the first refractive lens is an aspheric lens, the first refractive lens is an even-aspheric lens.

5. The optical system working at the far-infrared waveband according to claim 4, wherein an even-order aspheric surface of the even-aspheric lens satisfies a formula as follows:
$$Z ( r ) = \frac{c {r}^{2}}{1 + \sqrt{1 - ( 1 + k ) {c}^{2} {r}^{2}}} + A {r}^{4} + B {r}^{6} + C {r}^{8} + D {r}^{10}$$
wherein r is a radius of any position of the aspheric surface in a radial direction, Z(r) is a vector height of the aspheric surface, c is a curvature of the aspheric surface, k is a conic coefficient, A is a four-order aspheric coefficient, B is a six-order aspheric coefficient, C is an eight-order aspheric coefficient, and D is a ten-order aspheric coefficient.

6. The optical system working at the far-infrared waveband according to claim 1, wherein the optical system working at the far-infrared waveband satisfies a condition as follows:
$$\frac{f}{D} < 1.1$$
wherein f is an effective focal length of the optical system working at the far-infrared waveband, and D is an entrance pupil diameter of the optical system working at the far-infrared waveband.

7. The optical system working at the far-infrared waveband according to claim 6, wherein the optical system working at the far-infrared waveband satisfies a condition as follows:
$$\frac{f}{D} < 0.98 .$$

8. The optical system working at the far-infrared waveband according to claim 1, wherein the optical system working at the far-infrared waveband satisfies a condition with a unit of 1/° C. as follows:
$$- 9. E - 05 < \frac{{n}_{a 1} * \frac{d {n}_{a 1}}{d t} * f}{{f}_{a 1}} + \frac{{n}_{a 2} * \frac{d {n}_{a 2}}{d t} * f}{{f}_{a 2}} < 9. E - 05$$
wherein nₐ₁ is a refraction is a refractive index of the first refractive lens,
$$\frac{d {n}_{a 1}}{dt}$$
is a refraction temperature coefficient of the first refractive lens, fₐ₁ is a focal length of the first refractive lens, f is an effective focal length of the optical system, nₐ₂ is a refractive index of the second aspheric lens,
$$\frac{d {n}_{a 2}}{dt}$$
is a refraction temperature coefficient of the second aspheric lens, and fₐ₂ is a focal length of the second aspheric lens.

9. The optical system working at the far-infrared waveband according to claim 8, wherein the optical system satisfies a condition with the unit of 1/° C. as follows:
$$4.00 E - 05 < \frac{{n}_{a 1} * \frac{d {n}_{a 1}}{d t} * f}{{f}_{a 1}} + \frac{{n}_{a 2} * \frac{d {n}_{a 2}}{d t} * f}{{f}_{a 2}} < 8.00 E - 5.$$

10. The optical system working at the far-infrared waveband according to claim 1, wherein the optical system working at the far-infrared waveband satisfies a condition with a unit of mm as follows:
$$4 < \frac{T T L * FOV}{f * B F L} < 6$$
wherein TTL is a total track length of the optical system working at the far-infrared waveband, FOV is a full field of view of the optical system working at the far-infrared waveband, f is an effective focal length of the optical system working at the far-infrared waveband, BFL is a back focal length of the optical system working at the far-infrared waveband.

11. The optical system according to claim 1, wherein the optical system working at the far-infrared waveband satisfies the condition as follows:
$$0.1 < \vert \frac{{d}_{1} + {d}_{2}}{{R}_{1} + {R}_{2}} \vert * \frac{f}{{f}_{a 1}} < 0.6$$
$$0.1 < \vert \frac{{d}_{5} + {d}_{6}}{{R}_{5} + {R}_{6}} \vert * \frac{f}{{f}_{a 2}} < 0.6$$
wherein d₁ is a radius of an aperture of the object-side surface of the first refractive lens; d₂ is a radius of an aperture of the image-side surface of the first refractive lens; R₁ is a curvature radius of the object-side surface of the first refractive lens; R₂ s a curvature radius of the image-side surface of the first refractive lens; fₐ₁ is a focal length of the first refractive lens; d₅ is a radius of an aperture of the object-side surface of the second aspheric lens; d₆ is a radius of an aperture of the image-side surface of the second aspheric lens; R₅ is a curvature radius of the object-side surface of the second aspheric lens; R₆ is a curvature radius of the image-side surface of the second aspheric lens; fₐ₂ is a focal length of the second aspheric lens; and f is an effective focal length of the optical system working at the far-infrared waveband.

12. The optical system according to claim 1, wherein the optical system working at the far-infrared waveband satisfies a condition with a unit of mm/rad as follows:
$$0.01 < \frac{{d}_{m} * {f}_{m}}{φ * f} < 1.50$$
wherein dₘ is a radius of the metalens; fₘ is a focal length of the metalens; φ is a sum of absolute values of a phase difference of a position interval of a phase curve, and the phase curve is configured to describe phases at each position of the metalens in a radial direction, and the position interval of the phase curve from a center of the metalens to an edge of the metalens;
and f is an effective focal length of the optical system working at the far-infrared waveband.

13. The optical system according to claim 12, wherein the optical system working at the far-infrared waveband satisfies a condition with the unit of mm/rad as follows:
$$0.02 < \frac{{d}_{m} * {f}_{m}}{φ * f} < 1.00 .$$

14. The optical system according to claim 1, wherein the optical system working at the far-infrared waveband further comprises:
an aperture slot, and the aperture slot is set on the object side of the metalens.

15. The optical system according to claim 1, wherein a total track length of the optical system working at the far-infrared waveband is less than 29 mm.

16. The optical system according to claim 1, wherein a back focal length of the optical system working at the far-infrared waveband is greater than or equal to 9 mm, and is less than or equal to 9.45 mm.

17. The optical system according to claim 1, wherein a focal length of the metalens is greater than or equal to 28.8 mm, and is less than or equal to 102 mm;
a focal length of the first refractive lens is greater than or equal to 26 mm, and is less than or equal to 47.7 mm;
a focal length of the second aspheric lens is greater than or equal to 17.9 mm, and is less than or equal to 43.3 mm.

18. The optical system according to claim 1, wherein a radius of the metalens is greater than or equal to 5.8 mm, and is less than or equal to 8 mm.

19. An optical camera working at the far-infrared waveband, wherein the optical camera working at the far-infrared waveband comprises the optical system working at the far-infrared waveband of claim 1 and an imaging detector;
the imaging detector is set on an image plane of the optical system working at the far-infrared waveband.

20. The optical camera working at the far-infrared waveband according to claim 19,
wherein the optical camera working at the far-infrared waveband further comprises a window glass; the window glass is set between the second aspheric lens and the image side of the optical system working at the far-infrared.
